(19) United States
(12) Patent Application Publication
(10) Pub. No.: US 2025/0076456 A1
(43) Pub. Date: Mar. 6, 2025

(54) DEVICE AND METHOD FOR SENSING SYSTEM

(71) Applicant: Samsung Electronics Co., Ltd., Suwon-si (KR)

(72) Inventors: Jong-Sok KIM, Suwon-si (KR); Seung Tae KHANG, Suwon-si (KR)

(73) Assignee: Samsung Electronics Co., Ltd., Suwon-si (KR)

(21) Appl. No.: 18/737,686

(22) Filed: Jun. 7, 2024

(30) Foreign Application Priority Data
Sep. 6, 2023 (KR) 10-2023-0118299

(51) Int. Cl. G01S 7/35; G01S 13/931

(52) U.S. Cl. CPC G01S 7/35; G01S 13/931

(57) ABSTRACT

A processor-implemented method includes receiving at least one information comprising either one or both of control information of a vehicle and environment information of the vehicle; determining a driving situation of the vehicle, based on the at least one information; changing control parameters for changing a waveform of radar sensors of a sensing system, based on the determined driving situation of the vehicle, wherein the control parameters comprise an operation mode comprising a chirp mode of the radar sensors and comprise sensor parameters of the radar sensors; and transmitting the changed control parameters to the sensing system in real time.

### CROSS-REFERENCE TO RELATED APPLICATIONS

This application claims the benefit under 35 USC § 119 (a) of Korean Patent Application No. 10-2023-0118299, filed on Sep. 6, 2023 in the Korean Intellectual Property Office, the entire disclosure of which is incorporated herein by reference for all purposes.

### BACKGROUND

### 1. Field

The following description relates to a device and method for a sensing system.

### 2. Description of Related Art

An advanced driver-assistance system (ADAS) is a system that may support driving to improve drivers' safety and convenience and to avoid dangerous situations by using sensors mounted inside or outside a vehicle.

Sensors used in an ADAS may include, for example, a camera, an infrared sensor, an ultrasonic sensor, a light detection and ranging (lidar), and a radar. A lidar may recognize an object precisely in three dimensions by measuring distance, width, and height information but may be sensitive to the influence of an external environment. A radar may use a wave instead of a laser used by the lidar. The radar may identify the distance, speed, and direction information of an object by emitting a wave and using data returned after the wave hits the object. The radar may stably measure an object in the vicinity of a vehicle regardless of a surrounding environment, such as weather, compared to an optical-based sensor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: receiving at least one information comprising either one or both of control information of a vehicle and environment information of the vehicle; determining a driving situation of the vehicle, based on the at least one information; changing control parameters for changing a waveform of radar sensors of a sensing system, based on the determined driving situation of the vehicle, wherein the control parameters comprise an operation mode comprising a chirp mode of the radar sensors and comprise sensor parameters of the radar sensors; and transmitting the changed control parameters to the sensing system in real time.

The driving situation of the vehicle may include any one or any combination of any two or more of an event occurrence state in which another object approaches the vehicle, a parked state of the vehicle, a stopped state of the vehicle, a road driving state of the vehicle, a low-speed driving state of the vehicle, a high-speed driving state of the vehicle, a tunnel entry state of the vehicle, and a congested area driving state in which low speed objects are around the vehicle.

The determining the driving situation of the vehicle may include determining the driving situation of the vehicle, based on any one or any combination of any two or more of a driving speed of the vehicle, a type of a road on which the vehicle is driving, a sensing distance of the sensing system, and a field of view (FoV) of the sensing system, and the changing the control parameters may include changing the control parameters related to any one or any combination of any two or more of a sensing area of the sensing system, sensing sensitivity of the sensing system, and a resolution of the sensing system such that the control parameters match the driving situation of the vehicle.

The sensor parameters may include any one or any combination of any two or more of the number of chirp signals, whether the radar sensors are synchronized with one another, a sampling rate of the radar sensors, a range resolution of the radar sensors, a Doppler resolution of the radar sensors, a bandwidth (BW) of the radar sensors, a maximum sensing distance of the radar sensors, a sensing area of the radar sensors, an active damping control (ADC) start time, an idle time of the radar sensors, a ramp end time, a ramp slope, a frequency-modulated (FM) slope, the number of consecutive radar sensors, and the number of transmission antennas used for a time division mode.

The chirp mode may include: a first mode for performing time division for radar signals transmitted by the radar sensors; and a second mode for performing beamforming by the radar signals.

The changing the control parameters may include determining the chirp mode, based on any one or any combination of any two or more of a driving speed of the vehicle, a type of a road on which the vehicle is driving, a sensing distance of the sensing system, and a FoV of the sensing system, which correspond to the driving situation of the vehicle.

The determining the chirp mode may include: setting the chirp mode to the first mode in response to the sensing distance of the sensing system being less than or equal to a reference distance and a width of the FoV of the sensing system being greater than or equal to a reference width; and setting the chirp mode to the second mode in response to the sensing distance of the sensing system being greater than or equal to the reference distance and the width of the FoV of the sensing system being less than or equal to the reference width.

The operation mode may include any one or any combination of any two or more of: a focusing mode for focusing sensing of the sensing system on an area where an event occurs when the event in which another object approaches the vehicle occurs; a power saving mode for reducing the sensing sensitivity of the sensing system to reduce energy consumption of the vehicle; and a driving mode for adjusting the sensing sensitivity of the sensing system corresponding to the driving state of the vehicle, the stopped state of the vehicle, and the parked state of the vehicle.

The changing the control parameters may include: setting the operation mode to the focusing mode in response to the driving situation of the vehicle being the event occurrence state in which another object approaches the vehicle; and changing the control parameters such that sensing of the sensing system is focused on the area where the event occurs according to the focusing mode.

The sensing system further may include any one or any combination of any two or more of a long-wave infrared (LWIR) camera, a camera sensor, and a lidar, and the changing the control parameters further may include, in response to an area where another object approaches the vehicle being sensed by either one or both of the camera sensor and the lidar, setting the chirp mode to a second mode for performing beamforming such that the beamforming is performed on the area where the other object approaches the vehicle.

The changing the control parameters may include: setting the operation mode to a power saving mode in response to the driving situation of the vehicle being determined to be either one or both of a parked state and a stopped state; and according to the power saving mode, reducing a sampling rate of the radar sensors, synchronizing the radar sensors with one another, and setting the chirp mode to a first mode for sensing a short distance.

The changing the control parameters may include, in response to the driving situation of the vehicle being a tunnel entry state, setting the operation mode to a driving mode, setting the chirp mode to a second mode, and increasing the number of chirp signals according to the second mode.

The changing the control parameters may include: setting the operation mode to a focusing mode in response to the driving situation of the vehicle being a congested area driving state; and any one or any combination of any two or more of increasing a range resolution of the radar sensors according to the focusing mode, expanding a bandwidth (BW) of the radar sensors, and increasing the number of chirp signals to increase a Doppler resolution of the radar sensors.

A control device may be comprised by the vehicle and configured to communicate with the sensing system through a communication interface.

The method may include performing either one or both of: an update of a latest state of the vehicle through real-time signal processing (RSP) in response to sensing the radar sensors through over-the-air programming; and a debugging of the sensing system.

In one or more general aspects, a non-transitory computer-readable storage medium storing instructions that, when executed by one or more processors, configure the one or more processors to perform any one, any combination, or all of operations and methods disclosed herein.

In one or more general aspects, a processors-implemented method includes: receiving control parameters of radar sensors from a control device, wherein the control parameters may include a chirp mode of a wireless communication circuit of a vehicle; and transmitting a control signal according to the control parameters to the radar sensors.

The method may include downloading either one or both of a booting code for the wireless communication circuit of the vehicle and a chirp setting code for the wireless communication circuit of the vehicle from the control device.

In one or more general aspects, a control device includes: a communication interface configured to receive at least one information comprising either one or both of control information of a vehicle and environment information of the vehicle; and one or more processors configured to determine a driving situation of the vehicle, based on the at least one information, and to change control parameters of radar sensors of a sensing system for changing a waveform, based on the determined driving situation, wherein the control parameters may include an operation mode comprising a chirp mode of a wireless communication circuit of the vehicle and may include sensor parameters, and the communication interface is configured to transmit the changed control parameters to the sensing system in real time.

A vehicle may include the control device and the sensing system.

In one or more general aspects, a processor-implemented method includes: determining first values corresponding to a first driving situation of a vehicle and second values corresponding to a second driving situation of the vehicle of control parameters for changing a waveform of radar sensors of a sensing system, wherein the control parameters may include an operation mode comprising a chirp mode of the radar sensors and may include sensor parameters of the radar sensors; storing the first values and the second values respectively in a first memory address of the sensing system and a second memory address of the sensing system; selectively transmitting, to the sensing system, one of a first trigger signal corresponding to the first values and a second trigger signal corresponding to the second values, depending on whether a determined driving situation of the vehicle is the first driving situation or the second driving situation.

Other features and aspects will be apparent from the following detailed description, the drawings, and the claims.

### BRIEF DESCRIPTION OF THE DRAWINGS

FIG. 1 illustrates an example of a control flow between a sensing system and a control device.

FIG. 2 illustrates an example of an operating method of a control device.

FIG. 3 illustrates an example of sensor parameters.

FIG. 4 illustrates an example of an arrangement of a control module and radar sensors in a vehicle.

FIG. 5 illustrates an example of an operation between a control device and a sensing system.

FIG. 6 illustrates an example of a chirp mode of radar sensors.

FIG. 7 illustrates an example of control parameters changed depending on a driving situation of a vehicle.

FIG. 8 illustrates an example of a method of changing control parameters based on a driving situation of a vehicle.

FIG. 9 illustrates an example of a control method of a sensing system.

FIGS. 10A and 10B illustrate an operating method between a control device and a sensing system.

FIG. 11 illustrates an example of an operation between a sensing system and a control device.

FIG. 12 illustrates an example of a control device.

FIG. 13 illustrates an example of a vehicle.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as will be commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

The phrases “at least one of A, B, and C,” “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment (for example, as to what an example or embodiment may include or implement) means that at least one example or embodiment exists where such a feature is included or implemented, while all examples are not limited thereto.

Hereinafter, embodiments will be described in detail with reference to the accompanying drawings. When describing the embodiments with reference to the accompanying drawings, like reference numerals refer to like elements and a repeated description related thereto will be omitted.

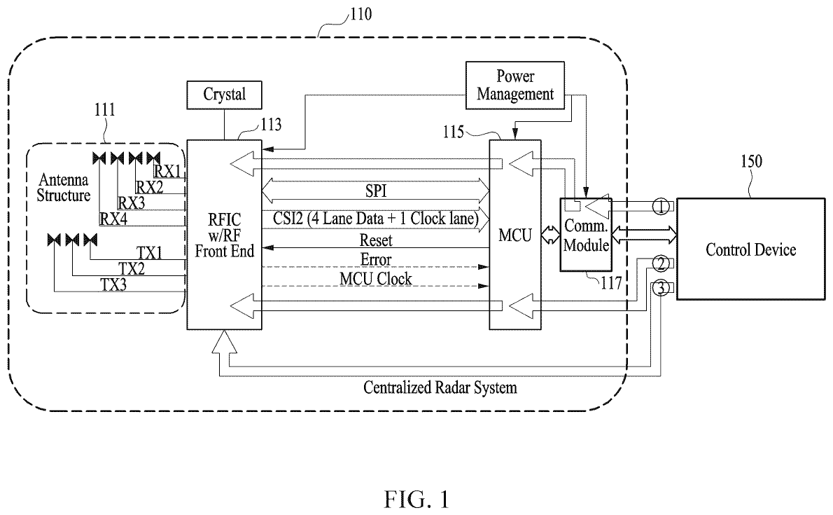

FIG. 1 illustrates an example of a control flow between a sensing system and a control device. FIG. 1 is a diagram illustrating a control flow of a control device 150 with respect to a sensing system 110 including radar sensors, according to one or more embodiments.

First, a boot-up sequence of a radar system may be typically performed as below, for example.

When power is supplied, a micro control unit (MCU) 115 may transmit a wakeup signal to a radio frequency integrated circuit (RFIC) 113. In this case, the RFIC 113 may include an RF front end for receiving and transmitting wireless frequency signals. The RF front end may include, for example, a power amplifier (PA), a duplexer and a diplexer, an RF switch, a filter low-noise amplifier (LNA), and/or a base band chip, but examples are not limited to the foregoing examples.

When the MCU 115 receives a certain response from the RFIC 113 in response to the transmission of the wakeup signal, the MCU 115 may transmit parameter set values for various radar radiation signals to the RFIC 113. The RFIC 113 may store the parameter set values in a memory and, based on the store parameter set values, may transmit chirp signals of a certain pattern through radar antennas 111.

In addition, the boot-up sequence of the radar system may also be performed in a method of storing parameter set values in an external memory (e.g., Q-flash memory) and using the values stored in the external memory by the RFIC 113 when receiving an instruction from the MCU 115, in which the MCU 115 still transmits a wakeup signal and receives a response from the RFIC 113.

However, the typical boot-up sequence described above may be a method of simply retrieving fixed parameter set values stored in the MCU 115 or a memory and proceeding with a boot-up of a system. Accordingly, it may be difficult for the typical boot-up sequence to implement various chirp signals depending on a surrounding situation in real time, and moreover, it may be difficult for the typical boot-up sequence to operate high performance radar sensors using multiple radar antennas.

In an example, the control device 150 of one or more embodiments outside the sensing system 110 may receive a control signal and/or control parameters for chirp signals generated by the RFIC 113. The chirp signals, of radar sensors, generated by the RFIC 113 may be changed according to the received control signal and/or control parameters from the control device 150. In this case, the control signal and/or the control parameters may include a set value of the chirp signals (or chirp parameters). The control signal 150 may change the form of a radiation signal of the radar sensors by changing the set value of the chirp signals. For example, a range resolution, Doppler resolution, maximum sensing distance, etc. of the radar sensors may be determined. The control device 150 may be, for example, at least one of or a combination of a vehicle control unit (VCU), a zonal controller, an MCU, and/or a centralized processor, but examples are not limited to the foregoing examples.

The control device 150 may entirely or partially perform the control related to the setting and control of a chirp parameter, the optimization and change of real-time signal processing (RSP), etc., besides the typical boot-up process of the RFIC 113 in the radar system described above.

The control device 150 may variously change a control signal and/or control parameters according to a certain interval, an external set value, and/or a change of a driving situation of a vehicle. In addition, set values of the control parameters provided by the control device 150 may be newly updated through over-the-air programming (OTA) to be described below. The updated set values of the control parameters through OTA may be reflected on the RFIC 113.

Further, the control device 150 may equally maintain a frame rate by changing the chirp signals suitable for a desired transmission distance, field of view (FoV), and/or a resolution and may also improve the computational power of the control device 150.

For example, the control device 150 may control the RFIC 113 by transmitting a control signal and/or control parameters through the MCU 115 and a communication module (Comm. Module) 117 as shown in path \textcircled{1} of FIG. 1. Alternatively, the control device 150 may control the RFIC 113 by transmitting a control signal and/or control parameters through the MCU 115 as shown in path \textcircled{2}. Otherwise, the control device 150 may control the RFIC 113 by directly transmitting a control signal and/or control parameters as shown in path \textcircled{3}.

The control device 150 may control and optimize a sensing area, resolution, sensing frame rate, synchronization frame, etc. of the radar sensors included in the sensing system 110 in real time, based on the current situation of the vehicle through the structure illustrated in FIG. 1. Further, the control device 150 may enable the update of all kinds of software including the control information of the vehicle through OTA.

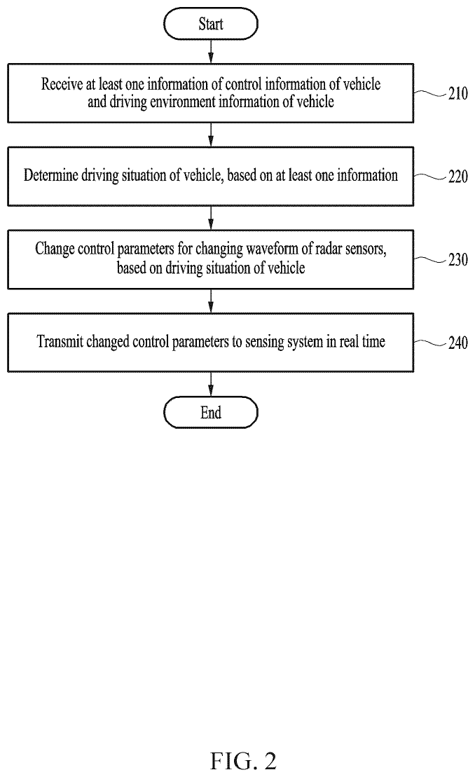

FIG. 2 illustrates an example of an operating method of a control device. Operations to be described hereinafter may be performed sequentially but not necessarily performed sequentially. For example, the order of the operations may change and at least two of the operations may be performed in parallel.

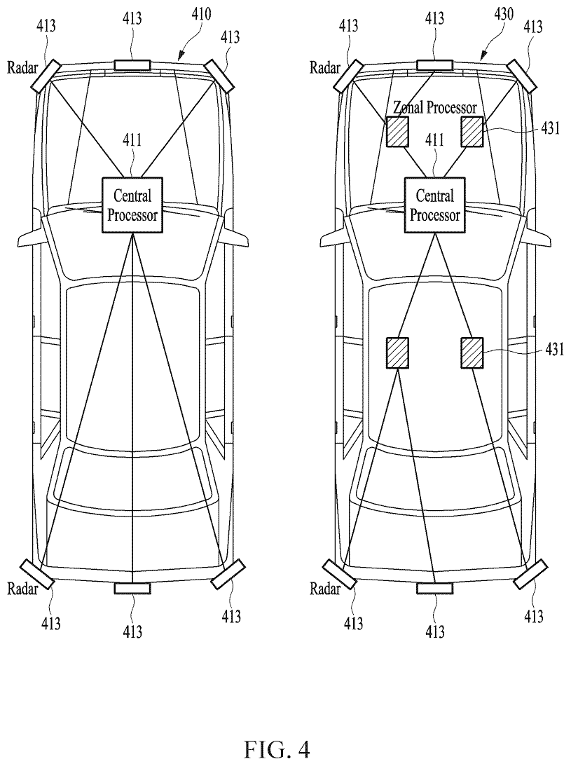

Referring to FIG. 2, a control device (e.g., the control device 150 of FIG. 1) for a sensing system including radar sensors may transmit control parameters to the sensing system (e.g., the sensing system 110 of FIG. 1) in real time through operations 210 to 240, according to one or more embodiments. The radar sensors may be positioned, for example, in the front of a vehicle, both sides of the front of the vehicle, the rear of the vehicle, and/or both sides of the rear of the vehicle, but examples are not limited thereto. An example of the arrangement of a control device and radar sensors is described in detail below with reference to FIG. 4. The sensing system may further include at least one of a long-wave infrared (LWIR) camera, a camera sensor, and a lidar.

In operation 210, the control device may receive, for example, at least one information of the control information of the vehicle and the driving environment information of the vehicle. The control information of the vehicle may include, for example, an engine state (whether to be on/off) of the vehicle, whether the vehicle is parked/stopped, an orientation angle of the vehicle, a driving speed of the vehicle, etc., but examples are not limited to the foregoing examples. The driving environment information of the vehicle may include, for example, the type of a road on which the vehicle is driving, whether the vehicle is driving in a congested area, or whether there is a pedestrian and/or another vehicle in an adjacent area, or other road environments where the vehicle is driving, but examples are not limited to the foregoing examples. The type of the road on which the vehicle is driving may include a driveway, a national highway, an expressway, a one-way street, or the like. The control device may receive at least one information of the control information of the vehicle and the driving environment information of the vehicle from the sensing system or through a separate device.

In operation 220, the control device may determine the driving situation of the vehicle, based on the at least one information received in operation 210. The driving situation of the vehicle may include, for example, one or a combination of an event occurrence state in which another object approaches the vehicle, a parked state of the vehicle, a stopped state of the vehicle, a road driving state of the vehicle, a low-speed driving state of the vehicle, a high-speed driving state of the vehicle, a tunnel entry state of the vehicle, and a congested area driving state in which low speed objects are around the vehicle, but examples are not limited to the foregoing examples.

The control device may determine the driving situation of the vehicle, based on at least one of the driving speed of the vehicle, the type of the road on which the vehicle is driving, a sensing distance of the sensing system, and an FoV of the sensing system. The FoV may vary depending on the size of a sensor and a lens magnification. The FoV may be obtained according to FoV=Sensor Size H or V/Lens Magnification

The control device may determine that the driving situation of the vehicle is the high-speed driving state, for example, when the driving speed of the vehicle is greater than 70 km/s, the FoV is less than a certain reference angle, and the sensing distance is greater than a reference distance. In addition, the control device may determine that the driving situation of the vehicle is the low-speed driving state when the driving speed of the vehicle is less than 40 km/s, the FoV is greater than the certain reference angle, and the sensing distance is less than the reference distance. Alternatively, the control device may determine that the driving situation of the vehicle is the congested area driving state according to the number of objects that are around the vehicle or approaching the vehicle.

In operation 230, the control device may change control parameters for changing a waveform of the radar sensors, based on the determined driving situation of the vehicle in operation 220. In this case, the control parameters may include an operation mode including a chirp mode of the radar sensors, and may include sensor parameters of the radar sensors.

The operation mode may include, for example, one or a combination of a focusing mode for focusing the sensing of the sensing system on an area where an event occurs as the event in which another object approaches the vehicle occurs, a power saving mode for reducing the sensing sensitivity of the sensing system to reduce energy consumption of the vehicle, and a driving mode for adjusting the sensing sensitivity of the sensing system corresponding to the driving state, stopped state, and parked state of the vehicle.

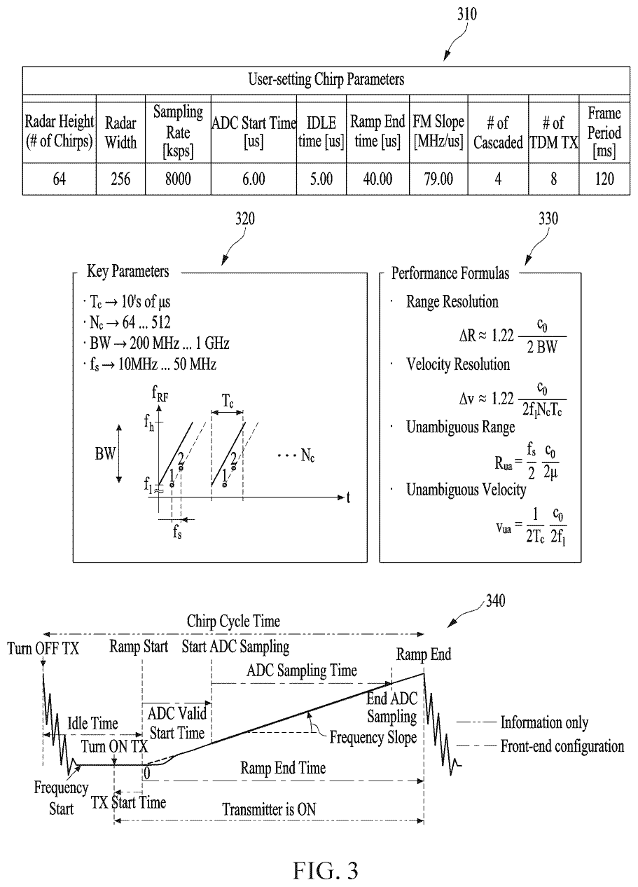

The sensor parameters may include, for example, at least one of the number of chirp signals, whether the radar sensors are synchronized with one another, a sampling rate of the radar sensors, a range resolution of the radar sensors, a Doppler resolution of the radar sensors, a bandwidth (BW) of the radar sensors, a maximum sensing distance of the radar sensors, a sensing area of the radar sensors, an active damping control (ADC) start time, an idle time of the radar sensors, a ramp end time, a ramp slope, a frequency-modulated (FM) slope, the number of consecutive radar sensors, and the number of transmission antennas used for a time division mode. The range resolution of the radar sensors may be obtained by dividing a frequency BW of a frequency signal into a plurality of frequency BWs and generating a plurality of chirp signals each having a different gradient of a frequency. A chirp signal may refer to a signal having an incremental or decremental frequency or phase over time. The sensor parameters may also be referred to as “chirp parameters” or “signal waveform parameters”. The Doppler resolution of the radar sensors may be obtained with respect to a target speed by performing Doppler processing on a reception signal obtained by using a pulse train (PT) having a short repetition interval. An example of the sensor parameters are described in detail below with reference to FIG. 3.

When the driving situation of the vehicle is determined, in operation 220, based on at least one of the driving speed of the vehicle, the type of the driving road of the vehicle, the sensing distance of the sensing system, and the FoV of the sensing system, the control device may change the control parameters related to the sensing area of the sensing system, the sensing sensitivity of the sensing system, and a resolution of the sensing system, in operation 230, such that the control parameters may match the driving situation of the vehicle.

For example, the control device may determine the chirp mode based on at least one of the driving speed of the vehicle, the type of the driving road of the vehicle, the sensing distance of the sensing system, and the FoV of the sensing system, which correspond to the driving situation of the vehicle. For example, when the sensing distance of the sensing system is a short distance less than the reference distance, and the FoV of the sensing system is an area of a first width greater than a reference width, the control device may set the chirp mode to a first mode.

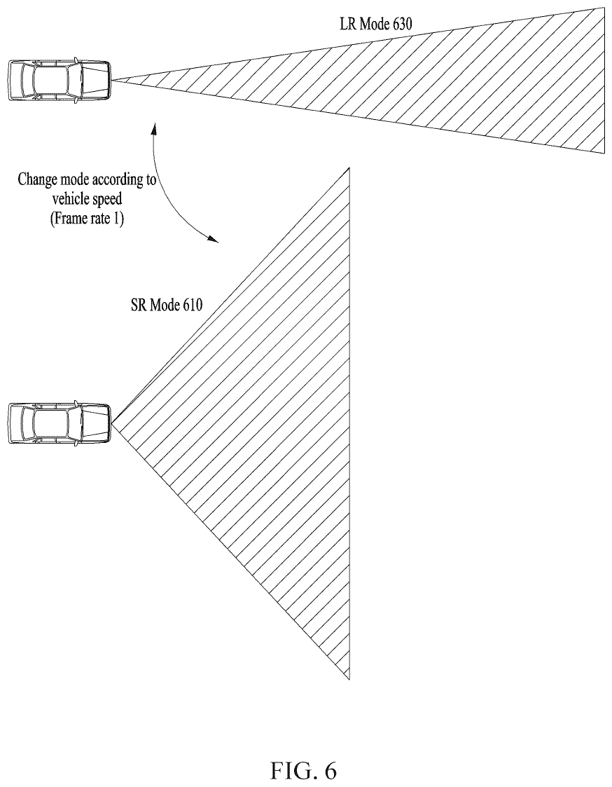

In addition, when the sensing distance of the sensing system is a long distance greater than the reference distance, and the FoV of the sensing system is an area of a second width less than the reference width, the control device may set the chirp mode to a second mode. An example of the chirp mode is described in detail below with reference to FIG. 6.

Alternatively, when the driving situation of the vehicle is the event occurrence state in which another object approaches the vehicle, the control device may set the operation mode to the focusing mode and may change the control parameters such that the sensing of the sensing system is focused on the area (focused area) where the event occurs according to the focusing mode. The control device may set the chirp mode to the second mode to perform beamforming on the focused area.

For example, when the sensing system further includes at least one of an LWIR camera, a camera sensor, and a lidar, and an area where another object approaches the vehicle is sensed by the camera sensor or the lidar, the control device may set the chirp mode to the second mode for performing beamforming such that the beamforming is performed on the area where the other object approaches the vehicle.

Alternatively, when the driving situation of the vehicle is determined to be the parked state or the stopped state, the control device may set the operation mode to the power saving mode. The control device may reduce the sampling rate of the radar sensors according to the power saving mode, synchronize the radar sensors with one another, and set the chirp mode to the first mode for sensing a short distance.

For example, when the driving situation of the vehicle is a tunnel entry state, the control device may set the operation mode to the driving mode. The control device may set the chirp mode to the second mode and may increase the number of chirp signals according to the second mode.

Alternatively, when the driving situation of the vehicle is a congested area driving state, the control device may set the operation mode to the focusing mode. The control device may change the control parameters such that the sensitivity of the radar sensors increases according to the focusing mode. For example, the control device may increase the range distance of the radar sensors, expand the BW of the radar sensors, and increase the number of chirp signals to increase the Doppler resolution of the radar sensors.

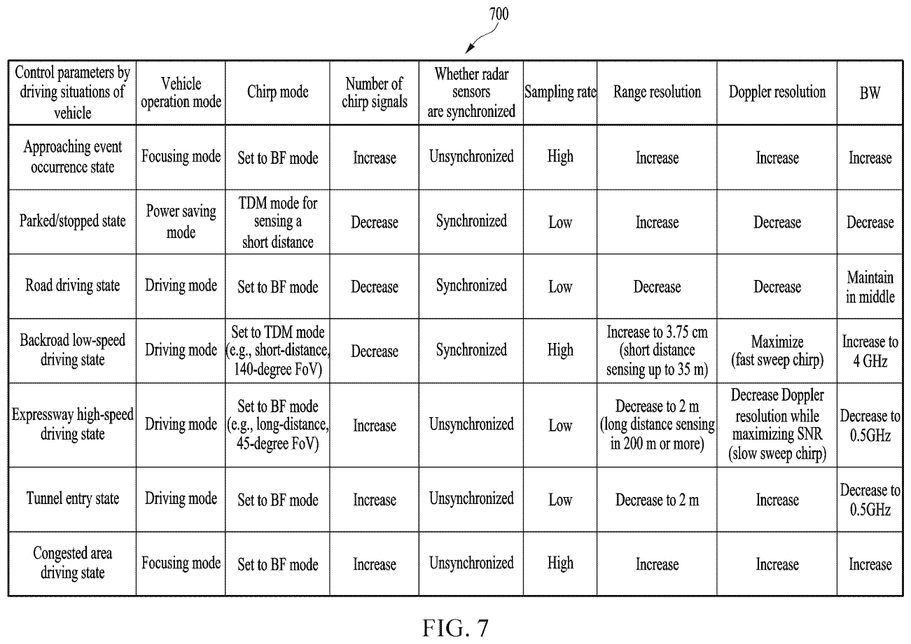

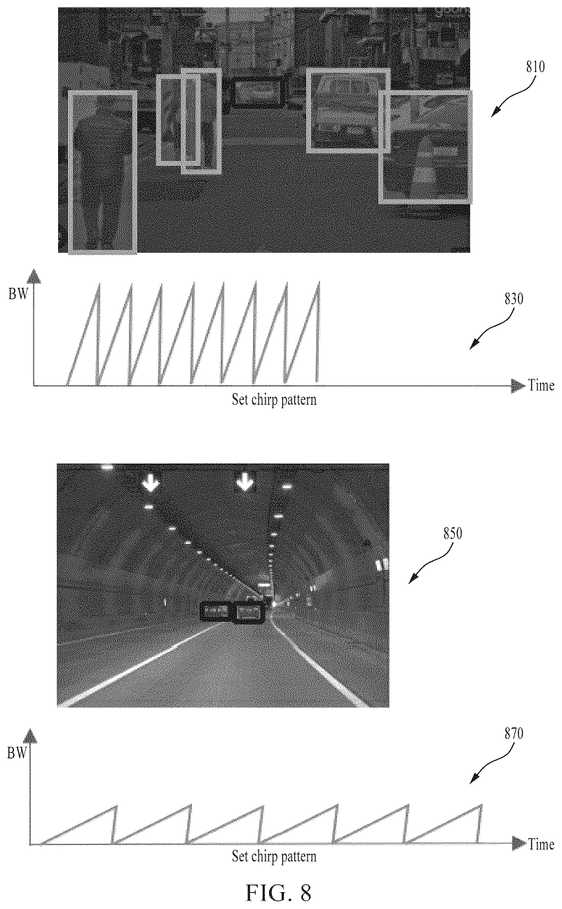

The control parameters may change depending on the driving situation of the vehicle as shown in graph of FIG. 7. In addition, an example of the method of changing the control parameters based on the driving situation of the vehicle by the control device is described in detail below with reference to FIG. 8.

In operation 240, the control device may transmit the control parameters changed in operation 230 to the sensing system in real time. The control device may be included, for example, in the vehicle and may communicate with the sensing system through a communication interface.

According to one or more embodiments, the control device may perform at least one of the update of the latest state of the vehicle through RSP when sensing the radar sensors through OTA and the debugging of the sensing system. The OTA may be a service for releasing new software, firmware, settings, encryption key updates wirelessly to a mobile phone, a set-top box, a vehicle, or other devices. When applying OTA to a vehicle, without separate reservation, universal serial bus (USB) connection, or other processes, the vehicle may be updated with the latest functions through the addition of new functions, such as the real-time information of a navigation or sound effects, the resolving of errors, or the like. In addition, when applying OTA to the vehicle, driver assistance functions, such as the prevention of lane departure, the prevention of collision, or autonomous driving, may be enhanced, and security updates to block hacking attacks may be allowed. Most vehicles may have to visit a repair shop to upgrade software functions, but the vehicle information of vehicles to which OTA is applied may be transmitted by a car manufacturer and may be applied directly by a driver. In addition, recall due to a partial defect of a vehicle may also be resolved through OTA, not through an engineer.

FIG. 3 illustrates an example of sensor parameters. Referring to FIG. 3, graph 310 and diagrams 320, 330, and 340 each illustrate the example of the sensor parameters changed by a control device, according to one or more embodiments.

As illustrated in graph 310 and diagram 340, the sensor parameters may include the number (#of Chirps) of chirp signals, a radar width of radar sensors, a sampling rate of the radar sensors, an ADC start time, an idle time of the radar sensors, a ramp end time, a ramp slope, the number (#of Cascaded) of consecutive radar sensors, the number (#of TDM TX) of transmission antennas used for a time division mode, and a frame period. In this case, the ramp slope may also be referred to as an FM slope.

As illustrated in diagram 320, the sensor parameters may include a period time (Tc) of a chirp signal, the number (Nc) of chirp signals, the BW of a chirp signal, and a transmission frequency (fₛ) of the radar sensors.

The sensor parameters may further include a Doppler resolution of the radar sensors other than a range resolution, velocity resolution, unambiguous range, and unambiguous velocity of the radar sensors, which are obtained through performance formulas illustrated in diagram 330.

In addition, as illustrated in diagram 340, the sensor parameters may further include a chirp cycle time, an ADC sampling time, a transmission start time (TX start time), and a frequency slope. The control device may control a sensing system according to a driving situation of a vehicle by changing a set value of the sensor parameters in real time according to the driving situation and transmitting the changed set value to the sensing system without storing the sensor parameters in advance in an MCU or a memory.

FIG. 4 illustrates an example of the arrangement of a control module and radar sensors in a vehicle. Referring to FIG. 4, diagram 410 illustrates an arrangement structure controlled through a control device including radar sensors 413 including a central processor 411 (e.g., one or more processors), and diagram 430 illustrates an arrangement structure controlled by a control device including the radar sensors 413 including the central processor 411 and a plurality of zonal controllers 431.

Referring to diagrams 410 and 430, the radar sensors 413 may be positioned in the front of the vehicle, both sides of the front of the vehicle, the rear of the vehicle, and both sides of the rear of the vehicle.

As illustrated in diagram 410, when the radar sensors 413 are controlled by the central processor 411, the central processor 411 may be positioned in the center of the front of the vehicle, as a non-limiting example.

Alternatively, as illustrated in diagram 430, when the radar sensors 413 are controlled by the control device including the central processor 411 and four zonal controllers 431, the four zonal controllers 431 may be controlled by the central processor 411. The four zonal controllers 431 may each control one or two radar sensors corresponding to a direction or position where each of the zonal controllers 431 is positioned according to a control signal of the central processor 411.

The control device may include one or a combination of a VCU and/or MCU other than the central processor 411 and the zonal controllers 431.

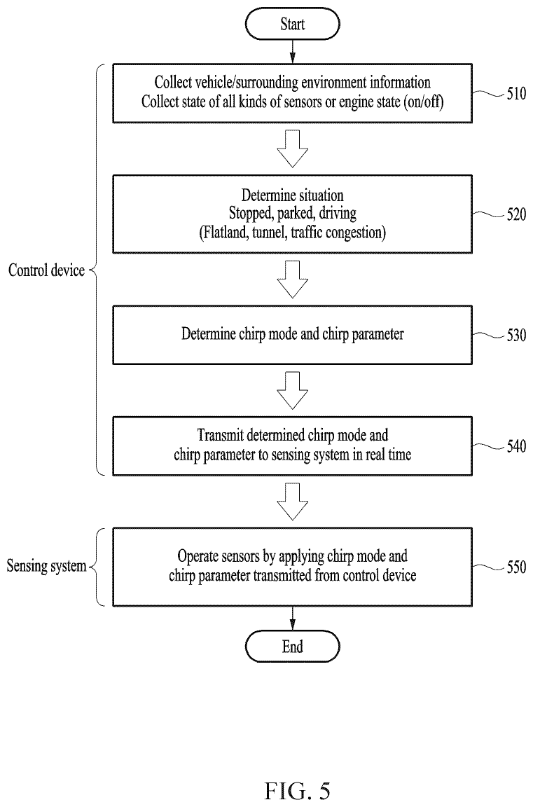

FIG. 5 illustrates an example of an operation between a control device and a sensing system. Operations to be described hereinafter may be performed sequentially but not necessarily performed sequentially. For example, the order of the operations may change and at least two of the operations may be performed in parallel.

Referring to FIG. 5, the control device may operate sensors of the sensing system through operations 510 to 550.

In operation 510, the control device may collect the information on a vehicle and/or surrounding environment information. The control device may collect a state of all kinds of sensors and/or an engine state of the vehicle.

In operation 520, the control device may determine a driving situation of the vehicle, based on the information collected in operation 510. The control device may determine, for example, whether the vehicle is in a stopped state, a parked state, or a driving state. In addition, when the vehicle is in the driving state, the control device may determine whether the vehicle is driving on a flat land, in a tunnel, or in traffic congestion, based on the collected information.

In operation 530, the control device may determine a chirp mode and a chirp parameter based on the determined driving situation of the vehicle in operation 520. The chirp mode and the chirp parameter may be included in the control parameters described above. The control parameters may determine, for example, whether to use a first mode or a second mode of the chirp mode according to a distance intended to be sensed through the sensing system including radar sensors and/or an FoV of the sensing system. The control parameters may be provided as a set of predefined set values or may each be changed by the control device to an optimal value according to a given situation, as non-limiting examples.

In operation 540, the control device may transmit the chirp mode and chirp parameter determined in operation 530 to the sensing system in real time. The sensing system receiving the chirp mode and the chirp parameter may transmit and receive radar signals according to the chirp mode and the chirp parameter without a separate reboot process.

In operation 550, the sensing system may operate the sensors (e.g., the radar sensors) by applying the chirp mode and chirp parameter transmitted in operation 540 from the control device.

FIG. 6 illustrates an example of a chirp mode of radar sensors. Referring to FIG. 6, diagram 610 illustrates an FoV and a sensing distance in a first mode of a chirp mode, and diagram 630 illustrates an FoV and a sensing distance in a second mode of the chirp mode, according to one or more embodiments.

Radar sensors of a typical radar system may cover an FoV and a sensing distance by alternating radar signals with one another at a certain time interval. When using said alternating method, a frame rate with respect to a certain FoV and a certain distance may decrease to ½ because the radar system may perform sensing alternately between a wide FOV of a short distance and a narrow FoV of a long distance. In addition, the utilization of computational power resources may also decrease to ½ as using the computational power resources to process data on a long-distance area in the alternating method even though a short distance may need to be viewed while low-speed driving.

In contrast, as a result of the control device of one or more embodiments dynamically changing control parameters including a chirp parameter according to a driving situation of a vehicle, a frame rate of a sensing system may increase compared to that of the typical radar system. In addition, as a result of the control device of one or more embodiments allowing an RFIC of the sensing system to have an optimal FoV and sensing distance according to the driving situation of the vehicle, the efficiency of computational power resources of the sensing system may also be improved.

According to one or more embodiments, the chirp mode may include the first mode for performing time division on radar signals radiating in a wide FoV of a short distance as illustrated in diagram 610 and the second mode for performing beamforming on radar signals radiating in a narrow FoV of a long distance as illustrated in diagram 630. The first mode may also be referred to as a “short range (SR) mode” since the radar signals radiate in a short distance. The second mode may also be referred to as a “long range (LR) mode” since the radar signals radiate over a long distance.

The control device of one or more embodiments may change the control parameters including the chirp mode in real time according to various driving situations including a speed of the vehicle.

FIG. 7 illustrates an example of control parameters changed depending on a driving situation of a vehicle. Referring to FIG. 7, graph 700 illustrates an example of a control device changing the control parameters depending on the driving situation of the vehicle, according to one or more embodiments.

For example, when an event in which an unknown object approaches in a certain area in the front sensed by a camera occurs, the control device may perform beamforming on radar signals with respect to the certain area by setting a chirp mode to a second mode and/or may improve sensing performance by increasing or decreasing a sensing threshold of radar sensors of a sensing system.

In addition, when the vehicle is in a stopped state or a parked state, the control device may change the chirp mode to a first mode suitable for a short distance and may change sensor parameters of the radar sensors to a value optimized for sensing a short distance. For example, the control device may sense the surroundings of the vehicle according to a power saving mode in which a frame rate is reduced.

For example, the vehicle may enter a tunnel while driving on a flat land. When the vehicle drives on the flat land, the control device may need to sense a wide area for a long distance and may sense a small reflection signal well since there is no noise due to the diffused reflection of an RF signal. Accordingly, the control device may change the setting of the control parameters to better sense a long distance rather than to be resistant to noise. The control device may change the control parameters, for example, by reducing a sensing threshold, which is a basis for determining whether there is an object through the reflection signal sensing of a radar sensor.

In addition, when the vehicle enters the tunnel, it is difficult to sense a reflection signal since the diffused reflection of an RF signal causes noise. In this case, the control device may change the setting of the control parameters to be resistant to noise. The control device may change the control parameters to be resistant to noise, for example, by increasing a sensing threshold of the radar sensors or by increasing the number of chirp signals.

In addition, when the vehicle is determined to be in a congested area driving state in which many low-speed objects are around the vehicle, the control device may increase a BW to increase a range resolution or may increase the number of chirp signals to enhance a Doppler feature.

The control device may also operate values of the control parameters in real time, or for example, may transmit the values to an RFIC or MCU by changing or adjusting the values as shown in a look-up table in graph 700. The driving situation of the vehicle and/or the control parameters by driving situations shown in graph 700 are just an example, and examples are not limited thereto.

FIG. 8 illustrates an example of a method of changing control parameters based on a driving situation of a vehicle. Referring to FIG. 8, diagram 810 illustrates a method of changing a control signal when a vehicle drives a backroad at a low speed, and diagram 850 illustrates a method of changing the control signal when the vehicle drives an expressway at a high speed, according to one or more embodiments.

When the vehicle drives a backroad crowded with pedestrians and other objects as illustrated in diagram 810, the control device may identify the current driving situation (e.g., a state in which the vehicle is driving a backroad where lanes are not distinguished or an alley and many pedestrians are around the vehicle) of the vehicle, based on information collected by various sensors included in the vehicle.

In the situation as illustrated in diagram 810, the control device may need to sense a wide range over a short distance minutely rather than a narrow range over a long distance. The control device may enable radar sensors to sense objects in a short distance (e.g., 35 m (meter)) minutely by increasing a BW to 4 gigahertz (GHz) such that the radar sensors have a high range resolution of 3.75 cm (centimeter). By doing so, the control device may identify a distance from a pedestrian precisely. In addition, the control device may sense a pedestrian near the vehicle and/or an object (e.g., another vehicle or a pedestrian) approaching the sides of the vehicle by changing a chirp mode to a first mode such that the radar sensors have a wide FoV (e.g., 140-degree FoV) in a short distance. Besides, the control device may precisely sense the movement of an object, such as a pedestrian or a bicycle, moving at a low speed by changing a chirp pattern to a fast sweep chirp pattern and maximizing a Doppler resolution as illustrated in diagram 830.

When the vehicle drives an expressway as illustrated in diagram 850, the control device may identify the current driving situation (e.g., a state in which the vehicle is driving an expressway at a high speed) of the vehicle, based on information collected by various sensors included in the vehicle.

In the high-speed driving situation as illustrated in diagram 850, the control device may need to rapidly sense a front area for a long distance rather than a short distance. In this case, the control device may decrease the BW to 0.5 GHZ as illustrated in diagram 870 such that sensing data have a low range resolution of 2 m. In this case, the radar sensors may rapidly sense a distance from objects in the front at a long distance (e.g., 200 m or more), but accuracy may decrease.

In addition, the control device may monitor vehicles in the same lane as that of the vehicle and in front of the vehicle by changing the chirp mode to a second mode such that the radar sensors have a narrow FoV (e.g., 45-degree FoV) at a long distance. Besides, the control device may enable the rapid sensing of an object at a long distance by changing the chirp pattern to a slow sweep chirp pattern such that a Doppler resolution decreases while a signal-to-noise ratio (SNR) is maximized.

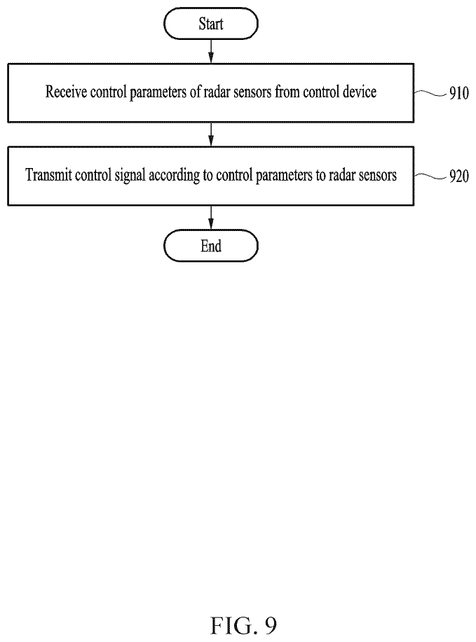

FIG. 9 illustrates an example of a control method of a sensing system. Operations to be described hereinafter may be performed sequentially but not necessarily performed sequentially. For example, the order of the operations may change and at least two of the operations may be performed in parallel.

Referring to FIG. 9, the sensing system may transmit a control signal according to control parameters to radar sensors through operations 910 and 920, according to one or more embodiments.

In operation 910, the sensing system may receive the control parameters of the radar sensors from a control device. In this case, the control parameters may include an operation mode including a chirp mode of a wireless communication circuit (e.g., the RFIC 113 of FIG. 1) of a vehicle and sensor parameters. According to one or more embodiments, the sensing system may download, from the control device, at least one of a booting code for the wireless communication circuit of the vehicle and a chirp setting code for the wireless communication circuit of the vehicle. In this case, the booting code may be a program for botting the wireless communication circuit of the vehicle and/or the sensing system. The chirp setting code may be a code value including a set value of a chirp parameter and/or a chirp mode.

In operation 920, the sensing system may transmit the control signal according to the control parameters received in operation 910 to the radar sensors.

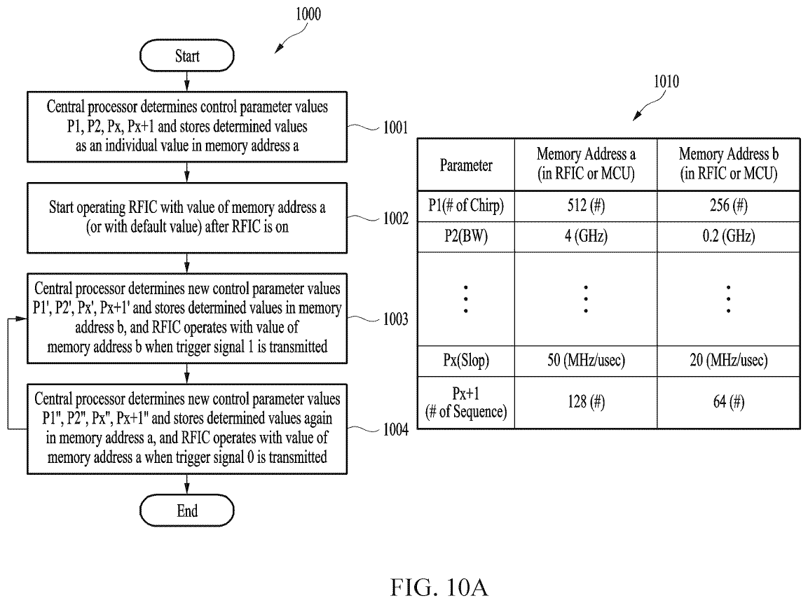

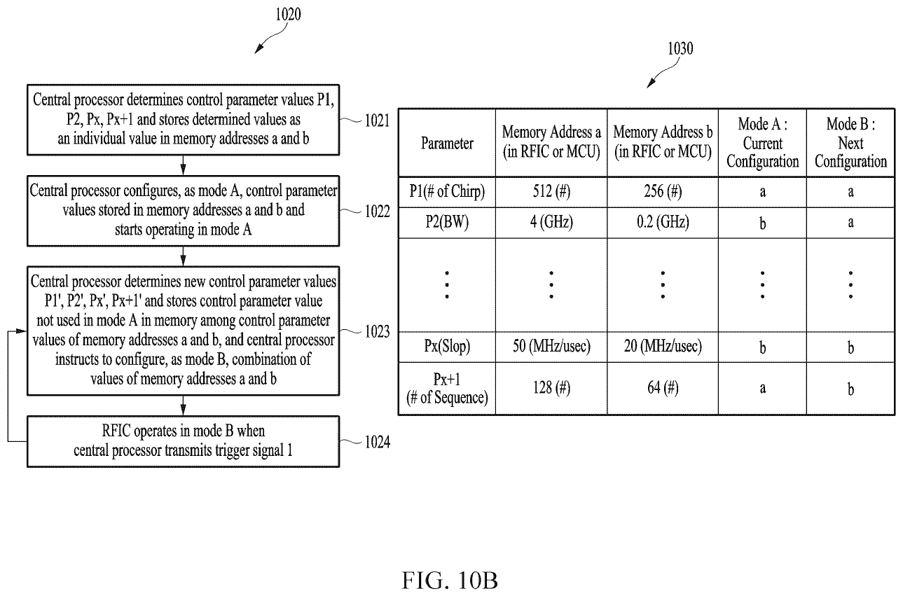

FIGS. 10A and 10B illustrate an operating method between a control device and a sensing system. Operations to be described hereinafter may be performed sequentially but not necessarily performed sequentially. For example, the order of the operations may change and at least two of the operations may be performed in parallel.

Referring to FIGS. 10A and 10B, flowcharts 1000 and 1020 each illustrate the operating method of the control device including a central processor, and tables 1010 and 1030 each illustrate control parameters changed according to the operating method, according to one or more embodiments.

Referring to FIG. 10A, the control device may operate an RFIC of the sensing system through operations 1001 to 1004.

In operation 1001, the central processor may determine values (e.g., P1, P2, Px, Px+1) of the control parameters of radar sensors and may store the determined values of the control parameters in memory address a as shown in graph 1010. The central processor may determine a value of a control parameter by using, for example, a driving situation of a vehicle, a desired sensing area, a distance, a sensed object, a speed of the sensed object, and an environmental factor, or the like.

In operation 1002, in response to the RFIC being on, the central processor may start operating the RFIC by using the value of the control parameter stored, through operation 1001, in memory address a. In this case, the central processor may start operating the RFIC with a preset default value, not memory address a.

In operation 1003, the central processor may determine new values (e.g., P1′, P2′, Px′, Px+1′) of the control parameters and may store the determined values of the control parameters in memory address b as shown in graph 1010. In this case, the central processor may transmit a trigger signal ‘1’ to the RFIC. The RFIC receiving the trigger signal ‘1’ may operate according to the values of the control parameters stored in memory address b.

In operation 1004, the central processor may determine new values (e.g., P1″, P2″, Px″, Px+1″) of the control parameters and may store the determined values of the control parameters again in memory address a. In this case, the central processor may transmit a trigger signal ‘0’ to the RFIC. The RFIC receiving the trigger signal ‘0’ may operate according to the values of the control parameters stored in memory address a.

The central processor may repeatedly perform operations 1004 and 1003 according to whether a trigger signal is ‘0’ or ‘1’.

Referring to FIG. 10B, the central processor may operate the RFIC through operations 1021 to 1024.

In operation 1021, the central processor may determine values (e.g., P1, P2, Px, Px+1) of the central parameters of the radar sensors and store the determined values as an individual value in memory addresses a and b as shown in graph 1030. The central processor may determine a value of a control parameter by using, for example, a driving situation of a vehicle, a desired sensing area, a distance, a sensed object, a speed of the sensed object, and an environmental factor, or the like.

In operation 1022, the central processor may configure, as mode A, a combination of the values of the control parameters stored in memory addresses a and b. The central processor may start operating the RFIC according to mode A.

In operation 1023, the central processor may determine new values (e.g., P1″, P2″, Px″, Px+1″) of the control parameters and may store, in a memory, a value of a control parameter that is not used in mode A among the values of the control parameters stored in memory addresses a and b. In this case, the central processor may configure, as mode B, a combination of the values of the control parameters stored in memory addresses a and b. Modes A and B may be optimized driving modes in which sensing performance is maximized for a desired sensing area, a desired sensing distance, an object desired to be sensed, a speed of the object desired to be sensed, and the surroundings (when passing an area, such as a tunnel or a bridge made of metal, where there is much noise).

In operation 1024, the RFIC may operate in mode B when the central processor transmits the trigger signal ‘1’ to the RFIC. In contrast, when the central processor transmits the trigger signal ‘0’ to the RFIC, the RFIC may operate in mode A.

For example, when the RFIC responds to a rising interval of a trigger signal, the RFIC may operate according to the trigger signal switching from 0 to 1. Alternatively, when the RFIC responds to both the rising interval of the trigger signal and a falling interval of the trigger signal, the RFIC may change from mode A to mode B in the rising interval and may change from mode B to mode A in the falling interval, or vice versa.

The central processor may repeatedly perform operations 1024 and 1023 according to whether the trigger signal is ‘0’ or ‘1’.

In the descriptions provided above with reference to FIGS. 10A and 10B, a memory may be included in the RFIC or an MCU or may be outside the sensing system or in the vehicle.

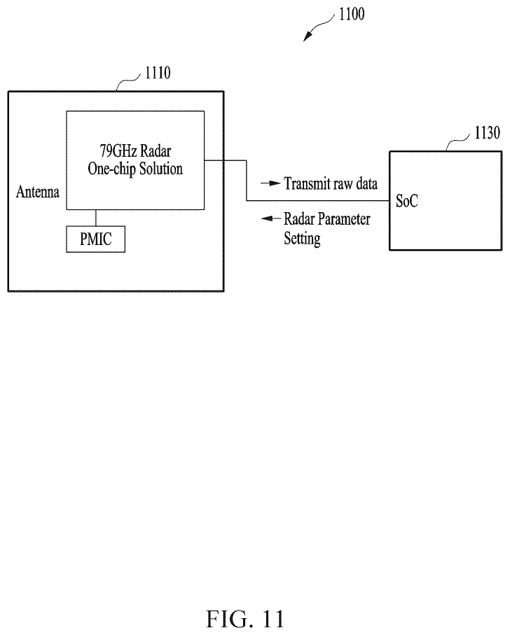

FIG. 11 illustrates an example of an operation between a sensing system and a control device. Referring to FIG. 11, diagram 1100 illustrates a sensing system 1110 and a control device 1130, according to one or more embodiments.

The sensing system 1110 may include, for example, radar antennas, a radar one-chip solution, and a power management integrated circuit (PMIC), but examples are not limited thereto. The radar one-chip solution may be a radar system including a radar front end, a low-specification MCU, a digital signal processor (DSP), and a communication module.

For example, the sensing system 1110 including radar sensors may perform signal processing internally, and the number of antennas for the radar sensors may increase by 10 times or more. In this case, a high-performance multiprocessor system on a chip (MP-SoC) may be used for real-time signal processing, but a typical method of using the high-performance MP-SoC may be pricy and may have limits in terms of the price, heat, weight, performance, or OTA of a sensing system.

In contrast, the sensing system 1110 of one or more embodiments including the radar sensors may be configured with a light system. The setting and control of control parameters and the signal processing of the radar sensors may be performed in the control device 1130 (e.g., SoC) outside (e.g., external to) the sensing system 1110. In addition, in an example, signal processing on raw data of the radar sensors may be performed in the control device 1130, and a value of initial control parameters for the radar sensors may also be controlled in the control device 1130. By doing so, the control device 1130 of one or more embodiments may optimize the sensing performance of the sensing system 1110, may minimize the price, heat, and weight of the sensing system 1110, and moreover, may enable the OTA for the control parameters.

The operations of the control device 1130 described above may be all applied to various sensors, such as radar sensors using a phase modulated continuous wave (PMCW) method, a Golay sequence, and/or a pulse other than radar sensors using a frequency modulated continuous wave (FMCW) method.

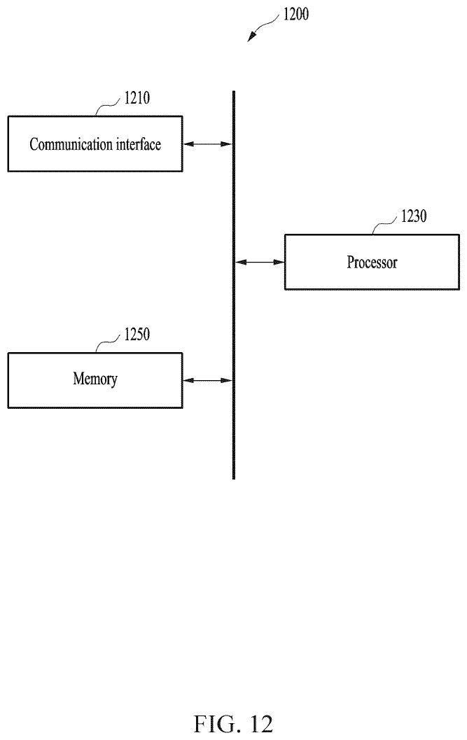

FIG. 12 illustrates an example of a control device. Referring to FIG. 12, a control device 1200 for a sensing system including radar sensors may include a communication interface 1210, a processor 1230 (e.g., one or more processors), and a memory 1250 (e.g., one or more memories), according to one or more embodiments. The communication interface 1210, the processor 1230, and the memory 1250 may communicate with one another via a communication bus.

The communication interface 1210 may receive at least one information of control information of a vehicle and driving environment information of the vehicle.

The processor 1230 may determine a driving situation of the vehicle, based on the at least one information received through the communication interface 1210. The processor 1230 may change control parameters of the radar sensors for a waveform change, based on the driving situation of the vehicle. The control parameters may include an operation mode including a chirp mode of a wireless communication circuit of the vehicle and sensor parameters.

The communication interface 1210 may transmit the control parameters changed by the processor 1230 to the sensing system in real time.

The memory 1250 may store various pieces of information generated in the processing of the processor 1230 described above. Besides, the memory 1250 may store various pieces of data, programs, or the like. The memory 1250 may include volatile memory or non-volatile memory. The memory 1250 may include a massive storage medium, such as a hard disk, and may store various pieces of data.

In addition, the processor 1230 may perform at least one method described above with reference to FIGS. 1 to 11 or an algorithm corresponding to the at least one method. The processor 1230 may be a hardware-implemented data processing device including a circuit that is physically structured to execute desired operations. The desired operations may include, for example, code or instructions included in a program. The processor 1230 may be implemented as, for example, a central processing unit (CPU), a graphics processing unit (GPU), or a neural network processing unit (NPU). The hardware-implemented control device 1200 may include, for example, a microprocessor, a CPU, a processor core, a multi-core processor, a multiprocessor, an application-specific integrated circuit (ASIC), and a field-programmable gate array (FPGA).

The processor 1230 may execute a program and may control the control device 1200. The program code executed by the processor 1230 may be stored in the memory 1250. For example, the memory 1250 may be or include a non-transitory computer-readable storage medium storing instructions that, when executed by the processor 1230, configure the processor 1230 to perform any one, any combination, or all of the operations and methods described herein with respect to FIGS. 1-13.

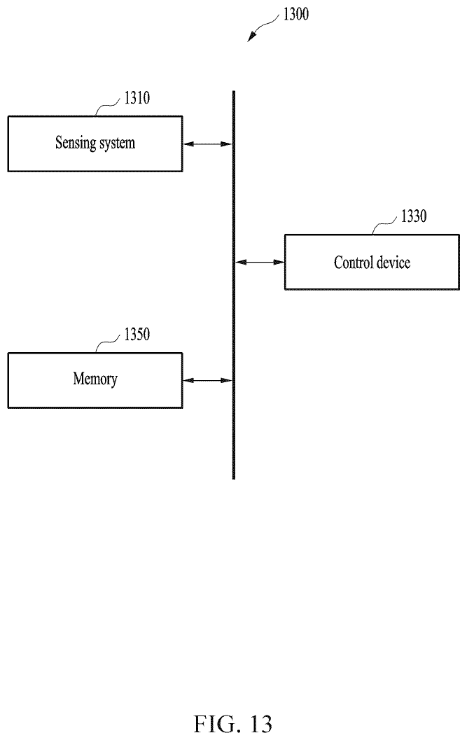

FIG. 13 illustrates an example of a vehicle. Referring to FIG. 13, a vehicle 1300 may include a sensing system 1310, a control device 1330, and a memory 1350, according to one or more embodiments. The sensing system 1310, the control device 1330, and the memory 1350 may communicate with one another via a communication bus.

The sensing system 1310 may include radar sensors and may generate at least one information of control information of a vehicle and driving environment information of the vehicle. The sensing system 1310 may be the sensing system 110 of FIG. 1, but examples are not limited thereto.

The control device 1330 may determine a driving situation of the vehicle, based on the at least one information generated in the sensing system 1310. The control device 1330 may change the control parameters of the radar sensors, based on the driving situation of the vehicle. In this case, the control parameters may include an operation mode including a chirp mode of a wireless communication circuit of the vehicle and sensor parameters. The control device 1330 may transmit the changed control parameters to the sensing system 1310 in real time.

The memory 1350 may store various pieces of information generated in the processing of the processor 1330 described above. Besides, the memory 1350 may store various pieces of data, programs, or the like. The memory 1350 may include volatile memory or non-volatile memory. The memory 1350 may include a massive storage medium, such as a hard disk, and may store various pieces of data.

In addition, the control device 1330 may perform at least one method described above with reference to FIGS. 1 to 12 or an algorithm corresponding to the at least one method. The control device 1330 may be a hardware-implemented data processing device including a circuit that is physically structured to execute desired operations. The desired operations may include, for example, code or instructions included in a program. The control device 1330 may be implemented as, for example, a CPU, a GPU, or an NPU. The hardware-implemented vehicle 1300 may include, for example, a microprocessor, a CPU, a processor core, a multi-core processor, a multiprocessor, an ASIC, and a FPGA.

The control device 1330 may execute a program and may control the vehicle 1300. The program code executed by the control device 1330 may be stored in the memory 1350. For example, the memory 1350 may be or include a non-transitory computer-readable storage medium storing instructions that, when executed by the control device 1330, configure the control device 1330 to perform any one, any combination, or all of the operations and methods described herein with respect to FIGS. 1-13.

The control devices, sensing systems, radar antennas, RFICs, MCUs, communication modules, radar sensors, central processors, zonal controllers, communication interfaces, processors, memories, vehicles, control device 150, sensing system 110, radar antennas 111, RFIC 113, MCU 115, communication module 117, radar sensors 413, central processor 411, zonal controllers 431, sensing system 1110, control device 1130, control device 1200, communication interface 1210, processor 1230, memory 1250, vehicle 1300, sensing system 1310, control device 1330, memory 1350, and other apparatuses, devices, units, modules, and components disclosed and described herein with respect to FIGS. 1-13 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
receiving at least one information comprising either one or both of control information of a vehicle and environment information of the vehicle;
determining a driving situation of the vehicle, based on the at least one information;
changing control parameters for changing a waveform of radar sensors of a sensing system, based on the determined driving situation of the vehicle, wherein the control parameters comprise an operation mode comprising a chirp mode of the radar sensors and comprise sensor parameters of the radar sensors; and
transmitting the changed control parameters to the sensing system in real time.

2. The method of claim 1, wherein the driving situation of the vehicle comprises any one or any combination of any two or more of an event occurrence state in which another object approaches the vehicle, a parked state of the vehicle, a stopped state of the vehicle, a road driving state of the vehicle, a low-speed driving state of the vehicle, a high-speed driving state of the vehicle, a tunnel entry state of the vehicle, and a congested area driving state in which low speed objects are around the vehicle.

3. The method of claim 1, wherein
the determining the driving situation of the vehicle comprises determining the driving situation of the vehicle, based on any one or any combination of any two or more of a driving speed of the vehicle, a type of a road on which the vehicle is driving, a sensing distance of the sensing system, and a field of view (FoV) of the sensing system, and
the changing the control parameters comprises changing the control parameters related to any one or any combination of any two or more of a sensing area of the sensing system, sensing sensitivity of the sensing system, and a resolution of the sensing system such that the control parameters match the driving situation of the vehicle.

4. The method of claim 1, wherein the sensor parameters comprise any one or any combination of any two or more of the number of chirp signals, whether the radar sensors are synchronized with one another, a sampling rate of the radar sensors, a range resolution of the radar sensors, a Doppler resolution of the radar sensors, a bandwidth (BW) of the radar sensors, a maximum sensing distance of the radar sensors, a sensing area of the radar sensors, an active damping control (ADC) start time, an idle time of the radar sensors, a ramp end time, a ramp slope, a frequency-modulated (FM) slope, the number of consecutive radar sensors, and the number of transmission antennas used for a time division mode.

5. The method of claim 1, wherein the chirp mode comprises:
a first mode for performing time division for radar signals transmitted by the radar sensors; and
a second mode for performing beamforming by the radar signals.

6. The method of claim 1, wherein the changing the control parameters comprises determining the chirp mode, based on any one or any combination of any two or more of a driving speed of the vehicle, a type of a road on which the vehicle is driving, a sensing distance of the sensing system, and a FoV of the sensing system, which correspond to the driving situation of the vehicle.

7. The method of claim 6, wherein the determining the chirp mode comprises:
setting the chirp mode to the first mode in response to the sensing distance of the sensing system being less than or equal to a reference distance and a width of the FoV of the sensing system being greater than or equal to a reference width; and
setting the chirp mode to the second mode in response to the sensing distance of the sensing system being greater than or equal to the reference distance and the width of the FoV of the sensing system being less than or equal to the reference width.

8. The method of claim 1, wherein the operation mode comprises any one or any combination of any two or more of:
a focusing mode for focusing sensing of the sensing system on an area where an event occurs when the event in which another object approaches the vehicle occurs;
a power saving mode for reducing the sensing sensitivity of the sensing system to reduce energy consumption of the vehicle; and
a driving mode for adjusting the sensing sensitivity of the sensing system corresponding to the driving state of the vehicle, the stopped state of the vehicle, and the parked state of the vehicle.

9. The method of claim 1, wherein the changing the control parameters comprises:
setting the operation mode to the focusing mode in response to the driving situation of the vehicle being the event occurrence state in which another object approaches the vehicle; and
changing the control parameters such that sensing of the sensing system is focused on the area where the event occurs according to the focusing mode.

10. The method of claim 9, wherein
the sensing system further comprises any one or any combination of any two or more of a long-wave infrared (LWIR) camera, a camera sensor, and a lidar, and
the changing the control parameters further comprises, in response to an area where another object approaches the vehicle being sensed by either one or both of the camera sensor and the lidar, setting the chirp mode to a second mode for performing beamforming such that the beamforming is performed on the area where the other object approaches the vehicle.

11. The method of claim 1, wherein the changing the control parameters comprises:
setting the operation mode to a power saving mode in response to the driving situation of the vehicle being determined to be either one or both of a parked state and a stopped state; and
according to the power saving mode, reducing a sampling rate of the radar sensors, synchronizing the radar sensors with one another, and setting the chirp mode to a first mode for sensing a short distance.

12. The method of claim 1, wherein the changing the control parameters comprises, in response to the driving situation of the vehicle being a tunnel entry state, setting the operation mode to a driving mode, setting the chirp mode to a second mode, and increasing the number of chirp signals according to the second mode.

13. The method of claim 1, wherein the changing the control parameters comprises:
setting the operation mode to a focusing mode in response to the driving situation of the vehicle being a congested area driving state; and
any one or any combination of any two or more of increasing a range resolution of the radar sensors according to the focusing mode, expanding a bandwidth (BW) of the radar sensors, and increasing the number of chirp signals to increase a Doppler resolution of the radar sensors.

14. The method of claim 1, wherein a control device is comprised by the vehicle and configured to communicate with the sensing system through a communication interface.

15. The method of claim 1, further comprising performing either one or both of:
an update of a latest state of the vehicle through real-time signal processing (RSP) in response to sensing the radar sensors through over-the-air programming; and
a debugging of the sensing system.

16. A non-transitory computer-readable storage medium storing instructions that, when executed by one or more processors, configure the one or more processors to perform the method of claim 1.

17. A processors-implemented method, the method comprising:
receiving control parameters of radar sensors from a control device, wherein the control parameters comprise a chirp mode of a wireless communication circuit of a vehicle; and
transmitting a control signal according to the control parameters to the radar sensors.

18. The method of claim 17, further comprising downloading either one or both of a booting code for the wireless communication circuit of the vehicle and a chirp setting code for the wireless communication circuit of the vehicle from the control device.

19. A control device comprising:
a communication interface configured to receive at least one information comprising either one or both of control information of a vehicle and environment information of the vehicle; and
one or more processors configured to determine a driving situation of the vehicle, based on the at least one information, and to change control parameters of radar sensors of a sensing system for changing a waveform, based on the determined driving situation, wherein the control parameters comprise an operation mode comprising a chirp mode of a wireless communication circuit of the vehicle and comprise sensor parameters,
wherein the communication interface is configured to transmit the changed control parameters to the sensing system in real time.

20. A vehicle comprising:
the control device of claim 19; and
the sensing system of claim 19.

21. A processor-implemented method comprising:
determining first values corresponding to a first driving situation of a vehicle and second values corresponding to a second driving situation of the vehicle of control parameters for changing a waveform of radar sensors of a sensing system, wherein the control parameters comprise an operation mode comprising a chirp mode of the radar sensors and comprise sensor parameters of the radar sensors;
storing the first values and the second values respectively in a first memory address of the sensing system and a second memory address of the sensing system; and
selectively transmitting, to the sensing system, one of a first trigger signal corresponding to the first values and a second trigger signal corresponding to the second values, depending on whether a determined driving situation of the vehicle is the first driving situation or the second driving situation.
